(19) United States
(12) Patent Application Publication
(10) Pub. No.: US 2022/0330522 A1
(43) Pub. Date: Oct. 20, 2022

(54) MOBILE INTERACTION DEVICE OF ANIMAL TAG, ANIMAL TAG SYSTEM AND METHOD FOR MODIFYING ANIMAL TAG

(71) Applicant: Yongchun Wang, Changzhou City (CN)

(72) Inventor: Yongchun Wang, Changzhou City (CN)

(21) Appl. No.: 17/234,823

(22) Filed: Apr. 20, 2021

(51) Int. Cl. A01K 11/00; A01K 29/00; H04W 4/80; G06F 16/2457

(52) U.S. Cl. CPC A01K 11/004; A01K 29/005; H04W 4/80; G06F 16/24575

(57) ABSTRACT

An animal tag includes a first electronic tag for implanting in an animal, the first electronic tag is provided with a first identification feature, and the first identification feature is configured for binding to the animal information of the animal. The mobile interaction device includes: an information transmission module, which carries instruction information and is provide outside the animal to transmit the instruction information to the mobile network terminal, so that the mobile network terminal can connect with a server to query the animal information; wherein, the instruction information includes retrieval information and domain name information of the server; and the retrieval information uniquely corresponds to the first identification feature, or uniquely corresponds to the animal information bound to the first identification feature. The disclosure relates to an animal tag system, a method for modifying the animal tag and a method for querying the information of the animal tag.

### TECHNICAL FIELD

The embodiment of the present disclosure relates to the technical field of animal tags, in particular to a mobile interaction method of an animal tag, an animal tag system and a method for modifying an animal tag.

### BACKGROUND

Animal electronic tag is a kind of radio frequency chip which is implanted into the subcutaneous tissue of animal for identifying animal identity. Each chip has a unique identification code in the world. The corresponding information of the animal implanted with the electronic tag can be queried through the identification code, such as: owner information, health and medical information, etc. When the animal is lost, others can query the corresponding owner's information through the identification code of the animal electronic tag and then contact the owner to return the animal. This kind of animal electronic tag has been widely used in some areas because of its small trauma, non-lost, safe and reliable characteristics, and has a great stock foundation. However, the existing animal electronic tags require special equipment to be identified, and these special equipment are generally only equipped by professional organizations, such as veterinary stations and animal protection organizations, which causes certain difficulties in obtaining animal information, wasting the time to retrieve the animals.

Thus, it is necessary to provide a new mobile interaction method of animal tags, an animal tag system and a transformation method to solve the above problems.

### SUMMARY

A mobile interaction device of an animal tag is provided by the embodiment of the present disclosure. The animal tag includes a first electronic tag for implanting in an animal, the first electronic tag is provided with a first identification feature, the first identification feature is configured for binding to animal information of the animal. The mobile interaction device includes an information transmission module which carries instruction information, and the information transmission module is provided outside the animal and configured for transmitting the instruction information to the mobile network terminal, so as to make the mobile network terminal connect with a server to query the animal information. Wherein the instruction information includes retrieval information and domain name information of the server, and the retrieval information uniquely corresponds to the first identification feature or the animal information bound to the first identification feature.

The embodiment of the invention further provides an animal tag system, including a first electronic tag for implanting in an animal and an information transmission module. The first electronic tag is provided with a first identification feature, and the first identification feature is configured for binding to animal information of the animal. The information transmission module carries instruction information, and the information transmission module is provided outside the animal and configured for transmitting the instruction information to the mobile network terminal, so as to make the mobile network terminal connect with a server to query the animal information. Wherein the instruction information includes retrieval information and domain name information of the server; the retrieval information uniquely corresponds to the first identification feature, or uniquely corresponds to the animal information bound to the first identification feature.

The embodiment of the invention further provides a method for modifying an animal tag, wherein the animal tag includes a first electronic tag for implanting in an animal, the first electronic tag is provided with a first identification feature, and the first identification feature is configured for binding to the animal information of the animal. The mobile interaction method includes generating retrieval information uniquely corresponding to the first identification feature or the animal information, wherein the animal information is animal information bound to the first identification feature; generating instruction information for connecting to a server to query the animal information, wherein the instruction information includes the retrieval information and domain name information of the server; and recording the instruction information in an information transmission module, wherein the information transmission module is provided outside the animal and configured to transmit the instruction information to a mobile network terminal.

The embodiment of the invention further provides a method for querying information of an animal tag, wherein the animal tag includes a first electronic tag for implanting in an animal, the first electronic tag is provided with a first identification feature, and the first identification feature is configured for binding to the animal information of the animal. The method includes generating retrieval information uniquely corresponding to the first identification feature or the animal information, wherein the animal information is the animal information bound to the first identification feature; generating instruction information for connecting to a server to query the animal information, wherein the instruction information includes the retrieval information and the domain name information of the server; recording the instruction information in an information transmission module, and the information transmission module is provided outside the animal; transmitting, by the information transmission module, the instruction information to the mobile network terminal to enable the mobile network terminal to connect with the server and send the retrieval information; retrieving, by the server, the corresponding animal information according to the retrieval information after receiving the retrieval information; and transmitting the corresponding animal information to the mobile network terminal in the case that there is matching animal information.

By adding a mobile interaction device on the basis of the existing implantable animal tag, the embodiments of the disclosure enables the information of the implantable animal tag to be queried in real time and conveniently through the mobile network terminal, which overcomes the shortcomings of the information query of the existing implantable animal tag that requires professional equipment and the query process is cumbersome, so that the smooth upgrade of the existing implantable animal tag is realized from traditional reading mode to mobile reading mode.

### BRIEF DESCRIPTION OF THE DRAWINGS

One or more embodiments are illustrated by the drawing in the corresponding drawings, which do not constitute the limitation to the embodiments. The elements with the same reference number in the drawings are represented as similar elements. Unless otherwise stated, the figures in the drawings do not constitute the limitation of proportion.

FIG. 1 is a schematic diagram of an animal tag system according to the first embodiment of the present disclosure;

FIG. 2 is a schematic diagram of the animal tag system according to the second embodiment of the present disclosure;

FIG. 3 is a flow chart of a method for querying animal tag information according to the first embodiment of the present disclosure;

FIG. 4 is a flow chart of the method for querying animal tag information according to the second embodiment of the present disclosure;

FIG. 5 is a flow chart of the method for querying animal tag information according to the third embodiment of the present disclosure;

FIG. 6 is a flow chart of the method for querying animal tag information according to the fourth embodiment of the present disclosure;

FIG. 7 is a flow chart of the method for querying animal tag information according to the fifth embodiment of the present disclosure.

### DETAILED DESCRIPTION OF THE EMBODIMENTS

The technical solution and the embodiment of the present disclosure will be described in detail in combination with the following drawings. However, those ordinary skilled person in the art should understand that many technical details have been proposed in order to make the reader better understand the application in various embodiments of the present disclosure, but even without these technical details and various changes and modifications based on the following embodiments, the technical solution claimed in the present application can be realized. The “binding” mentioned in the embodiment of the present disclosure refers to a one-to-one correspondence between the first information and the second information, and only the unique second information can be found according to the first information, and vice versa.

The embodiment of the present disclosure relates to a mobile interaction device of animal tags and an animal tag system including the mobile interaction device. Through the mobile interaction device, the animal tag system can interact with the mobile network terminal to query corresponding animal information through the mobile network terminal, thereby improving the convenience of obtaining animal information. Animal information may include: animal species, age, place of origin, epidemic prevention records, medical records, contact information of the animal owner, etc.

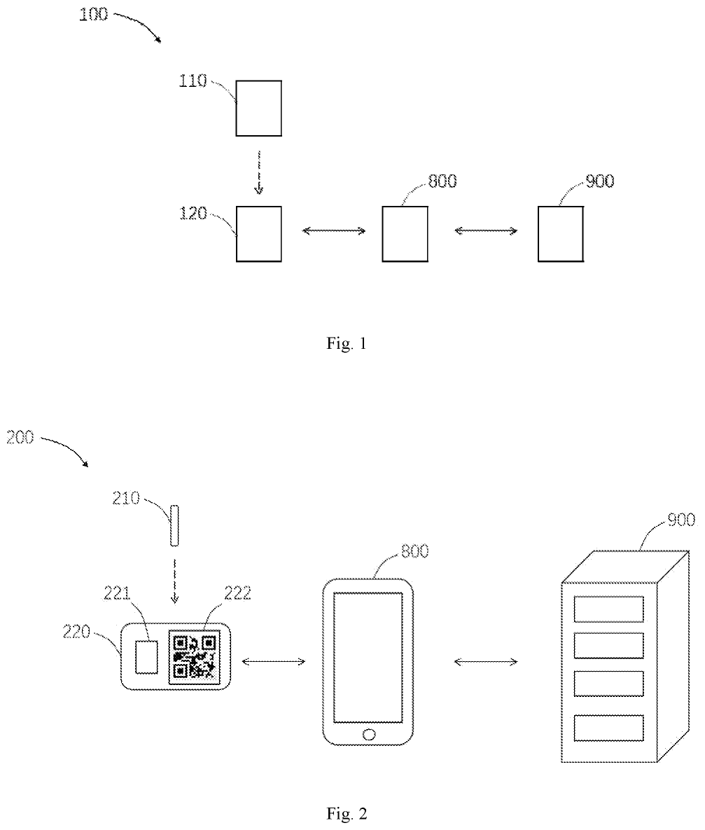

FIG. 1 is a schematic diagram of an animal tag system according to the first embodiment of the present disclosure. Referring to FIG. 1, the animal tag system 100 includes an animal tag 110 and a mobile interaction device 120. The mobile interaction device 120 is used together with the animal tag 110 to realize the mobile interactive function of the animal tag 110, that is, to enable the information in the animal tag 110 to be obtained by the mobile network terminal 800, and then the mobile network terminal 800 is used to connect with the server 900 to query the animal information bound to the animal tag.

Specifically, the animal tag 110 includes a first electronic tag. The first electronic tag is configured to be implanted in the animal, and the first electronic tag has a first identification feature. The first identification feature means that the feature of each first electronic tag can be distinguished from other similar electronic tags, such as the chip identification code of the first electronic tag. The chip identification code is globally unique. The first identification feature is configured for binding to the animal information of the implanted tag animal in a one-to-one correspondence, so that the unique animal information corresponding to the first identification feature can be queried based on the first identification feature. In some embodiments, the first electronic tag is a low-frequency radio frequency tag, and the working frequency of the low-frequency radio frequency tag is in the range of 100-150 kilohertz, for example: 134.2 kilohertz. The reading of the low-frequency radio frequency tag is less affected by temperature, humidity, and obstacles, and can penetrate water and organic tissues, so it is very suitable for use as an implantable electronic tag for animals. In some embodiments, a first database may be established to store the plurality of first identification features of the plurality of first electronic tags, the plurality of animal information, and the one-to-one correspondence between them.

The mobile interaction device 120 includes an information transmission module. The information transmission module 120 carries instruction information, which is used to notify the mobile network terminal 800 to connect to the server 900, so as to retrieve corresponding animal information. The instruction information includes retrieval information and domain name information of the server 900. The domain name information of the server 900 is used to enable the mobile network terminal 800 to find and connect to the corresponding server, and the retrieval information is sent to the server 900 as a basis for the server 900 to retrieve corresponding animal information in the database.

The retrieval information uniquely corresponds to the first identification feature, or the retrieval information uniquely corresponds to the animal information bound to the first identification feature. That is, according to the retrieval information, only the unique first electronic tag with the first identification feature can be found corresponding to it, or only the animal information of only one animal can be found corresponding to it.

In some embodiments, the retrieval information may be directly generated based on the first identification feature. For example, the retrieval information includes the chip identification code of the first electronic tag, or other unique code number generated after processing the chip identification code of the first electronic tag.

In other embodiments, the retrieval information may be generated based on the second identification feature, and the second identification feature is bound to at least one of the first identification feature and the animal information, that is: the second identification feature and the first identification feature are bound in an one-to-one correspondence, or the second identification feature and the animal information are bound in an one-to-one correspondence, or the second identification feature, the first identification feature, and the animal information are all bound to each other. In some embodiments, the animal information here refers to existing animal information bound to the first identification feature. In some embodiments, the second identification feature is an identification feature of the second electronic tag.

The information transmission module 120 is configured to be set outside the animal to transmit instruction information to the mobile network terminal 800, so that the mobile network terminal 800 executes corresponding instructions, that is, connects to the server 900 to query corresponding animal information. In some embodiments, the information transmission module 120 is connected or fixed to a wearable device of the animal, such as a collar, a tag, a leg ring, a harness, etc., so that it is attached to the animal.

In some embodiments, the information transmission module 120 includes a second electronic tag, and the second electronic tag is a radio frequency tag, which is configured to transmit the instruction information to the mobile network terminal 800 via a radio frequency signal. Furthermore, in some embodiments, the second electronic tag is a high-frequency radio frequency tag, and its working frequency is in the range of 10-15 MHz, for example, about 13.56 MHz. In some embodiments, the second electronic tag is a near field communication tag (NFC tag), and the mobile network terminal includes an NFC communication module.

In some embodiments, the second electronic tag has a second identification feature, such as the chip identification code of the second electronic tag. The second identification feature can be bound to the first identification feature in a one-to-one correspondence; or the second identification feature can be bound in a one-to-one correspondence with the animal information derived from the first database; or the second identification feature and the corresponding first identification feature and the corresponding animal information are bound to each other. In this way, the corresponding animal information can be directly or indirectly queried based on the second identification feature. In such a case, the retrieval information may be generated based on the second identification feature, for example, the retrieval information includes the chip identification code of the second electronic tag, or other unique code number generated after processing the chip identification code of the second electronic tag, or the retrieval information includes a combination of the chip identification code of the first electronic tag and the chip identification code of the second electronic tag, or a unique code number generated after processing the combination.

In addition to transmitting the instruction information through radio frequency signals, in some other embodiments, the information transmission module 120 may transmit the instruction information to the mobile network terminal through image signals. Specifically, the information transmission module 120 includes an image display element. The image display component is used to display the image compiled according to the instruction information, which can be recognized by the mobile network terminal, so as to transmit the instruction information to the mobile network terminal 800 through the image signal. The image may be a bar code, quick response code, etc. After the mobile network terminal 800 recognizes the image, the instruction information included in the image is analyzed, executing the corresponding instruction.

FIG. 2 is a schematic diagram of an animal tag system according to a second embodiment of the present disclosure. Referring to FIG. 2, the animal tag system 200 includes a first electronic tag 210 for implanting inside an animal and an information transmission module 220 for setting outside the animal.

The first electronic tag 210 has a first chip identification code, and the first chip identification code is configured for binding to the animal information of the animal in a one-to-one correspondence with each other. Generally, the plurality of first chip identification codes of the plurality of first electronic tags, the animal information of the plurality of animals, and their one-to-one correspondence are stored in a database, which is recorded as the first database.

The information transmission module 220 includes an NFC tag 221 and an image display element 222.

The NFC tag 221 is provided with a second chip identification code, and the second chip identification code is bound to the first chip identification code of the corresponding first electronic tag 210 in a one-to-one correspondence. The NFC tag 221 stores instruction information and is configured to transmit the instruction information to the mobile network terminal 800, so that the mobile network terminal 800 can connect to the server 900 to query corresponding animal information. Specifically, the instruction information is a website (URL) that contains the domain name of the server 900, so that the mobile network terminal 800 can connect to the server 900. The directory path or file name of the web site includes the second chip identification code as the retrieval information or other unique identification codes obtained after processing the second chip identification code.

Here, the NFC tag is used as the second electronic tag because most mobile network terminals are provided with an NFC reading module, such as smart phones, so users can easily use the mobile network terminal to obtain the instruction information in the NFC tag, and then use the mobile network terminal to connect to the server to query the corresponding animal information.

The image display element 222 is configured to display a two-dimensional code (QR code), and the image display element 222 may be a picture printed with a two-dimensional code or an electronic display screen that displays a two-dimensional code. In addition, the two-dimensional code can also be displayed on the image display element 222 (that is, the information transmission module) by means of printing, engraving, or the like. The two-dimensional code is compiled according to the instruction information, that is, the above-mentioned URL. The mobile network terminal obtains the image signal transmitted by the two-dimensional code through a camera, the image signal is analyzed and restored into instruction information, and then the instruction information is executed.

In this embodiment, by adding a two-dimensional code on the basis of the NFC tag, the problem that some mobile network terminals cannot directly read the NFC tag because they do not have the NFC reading module is solved, and the usability of the mobile interaction function of the animal tag is enhanced. For example: in the case that the smart phone of user does not have an NFC reading module, the user can still use the smart phone to scan and recognize the two-dimensional code to obtain instruction information.

By adding a mobile interaction device on the basis of the existing implantable animal tag, the above embodiments related to the animal tag system enables the information of the implantable animal tag to be queried in real time and conveniently through the mobile network terminal, which overcomes the shortcomings of the information query of the existing implantable animal tag that requires professional equipment and the query process is cumbersome, so that the smooth upgrade of the existing implantable animal tag is realized from traditional reading mode to mobile reading mode.

The embodiment of the present disclosure also relates to a method for querying animal tag information. With this method, the information in the animal tag can be queried anytime and anywhere through the mobile network terminal, thereby realizing functions such as animal management and retrieval. Specifically, the method for querying animal tag information includes the steps of modifying the existing implantable animal tag to make it have a mobile interaction function, and the subsequent steps of acquiring retrieval information and retrieving through a mobile network.

The animal tag mentioned in the method includes the first electronic tag implanted in the animal, the first electronic tag is provided with the first identification feature, and the first identification feature is used to bind to the animal information which is implanted in the first electronic tag, so that corresponding animal information can be queried based on the first identification feature. The plurality of the first identification features of the plurality of the first electronic tags, the animal information of the plurality of animals and the one-to-one correspondence between them are stored in a database, which is recorded as the first database. The first database can be called by a server (denoted as: the first server) to retrieve and obtain information therein.

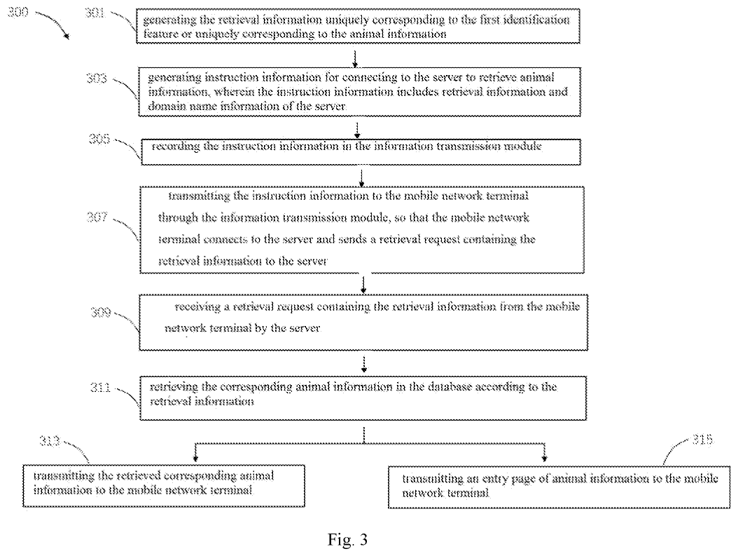

FIG. 3 is a flow chart of a method 300 for querying animal tag information according to the first embodiment of the present disclosure. Referring to FIG. 3, the method 300 includes steps 301-315, wherein the steps 301-305 relate to the method of modifying the animal tag, and the steps 307-315 relate to the subsequent mobile interaction steps.

In step 301, generating the retrieval information uniquely corresponding to the first identification feature or uniquely corresponding to the animal information, wherein the animal information refers to the animal information bound to the first identification feature.

In some embodiments, step 301 includes generating retrieval information according to the first identification feature to retrieve corresponding animal information. In other embodiments, step 301 includes: binding the second identification feature with at least one of the first identification feature and animal information; and generating retrieval information according to the second identification feature.

In step 303, generating instruction information for connecting to the server to retrieve animal information, wherein the instruction information includes retrieval information and domain name information of the server.

In step 305, recording the instruction information in the information transmission module, wherein the information transmission module is provided outside the animal and used to transmit the instruction information carried by the information transmission module to the mobile network terminal.

In some embodiments, the information transmission module includes a second electronic tag, which is used to transmit instruction information to the mobile network terminal through radio frequency information. Step 305 includes that writing the instruction information into the second electronic tag. In other embodiments, the information transmission module includes an image display element for transmitting instruction information to the mobile network terminal through an image signal. Step 305 includes compiling the instruction information into an image; and displaying the image on the image display element.

In step 307, transmitting the instruction information to the mobile network terminal through the information transmission module, so that the mobile network terminal connects to the server and sends a retrieval request containing the retrieval information to the server.

In step 309, receiving a retrieval request containing the retrieval information from the mobile network terminal by the server.

In step 311, retrieving the corresponding animal information in the database according to the retrieval information; the database may be the first database available, or a newly-built or updated database including the second identification feature.

In the case that there is matching animal information, step 313 is executed, that is, transmitting the retrieved corresponding animal information to the mobile network terminal.

In the case that there is no matching animal information, step 315 is executed, that is, transmitting an entry page of animal information to the mobile network terminal to prompt the user to enter animal information.

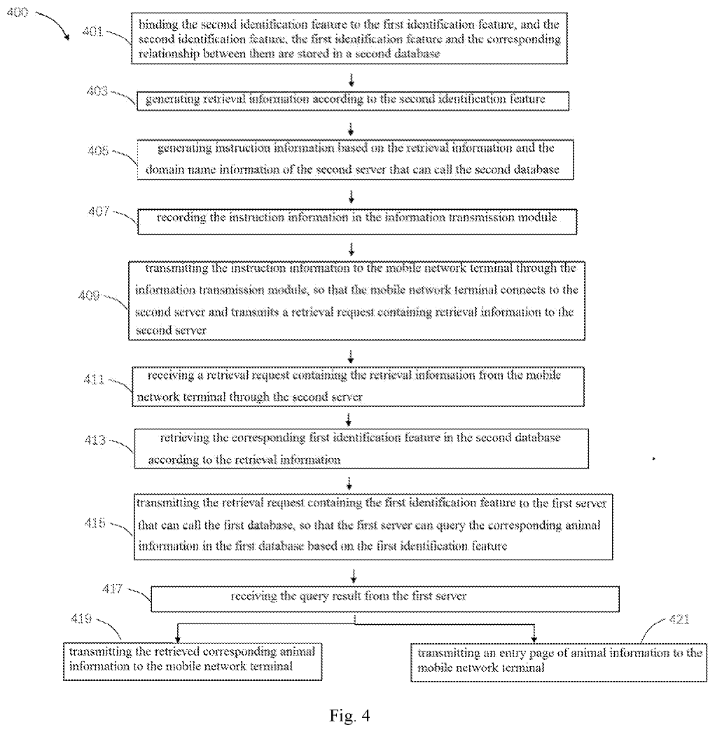

FIG. 4 is a flow chart of a method 400 for querying animal tag information according to the second embodiment of the present disclosure. Referring to FIG. 4, the method 400 includes steps 401-421, wherein the steps 401-407 relate to the method of modifying animal tags, and the steps 409-421 relate to the subsequent mobile interaction steps.

In step 401, binding the second identification feature to the first identification feature, and the second identification feature, the first identification feature and the corresponding relationship between them are stored in a second database. Specifically, the second identification feature may be a unique identification feature of the second electronic tag, such as: a second chip identification code or a unique code number obtained by processing or encrypting the second chip identification code. The second identification feature can also be other unique features that can distinguish each first identification feature. Specifically, the first identification feature can be directly derived from the first database, or obtained through a query on the website of an international organization that manages the chip, or directly read from the first electronic tag through the reading device.

In step 403, generating retrieval information according to the second identification feature.

In step 405, generating instruction information based on the retrieval information and the domain name information of the second server that can call the second database.

In step 407, recording the instruction information in the information transmission module, wherein the information transmission module is provided outside the animal to transmit the instruction information to the mobile network terminal.

In step 409, transmitting the instruction information to the mobile network terminal through the information transmission module, so that the mobile network terminal connects to the second server and transmits a retrieval request containing retrieval information to the second server.

In step 411, receiving a retrieval request containing the retrieval information from the mobile network terminal through the second server.

In step 413, retrieving the corresponding first identification feature in the second database according to the retrieval information.

In step 415, transmitting the retrieval request containing the first identification feature found in step 413 to the first server that can call the first database, so that the first server can query the corresponding animal information in the first database based on the first identification feature.

In step 417, receiving the query result from the first server; the query result may be matched animal information or non-existent matched animal information.

In the case that there is matching animal information, step 419 is executed, that is, transmitting the retrieved corresponding animal information to the mobile network terminal. Specifically, the original display page of animal information generated by the first server can be sent directly; or the display page generated by the second server containing corresponding animal information can be sent.

In the case that there is no matching animal information, step 421 is executed, that is, transmitting an entry page of animal information to the mobile network terminal to prompt the user to enter animal information. Specifically, the entry page of the animal information may be generated by the first server, or may also be generated by the second server.

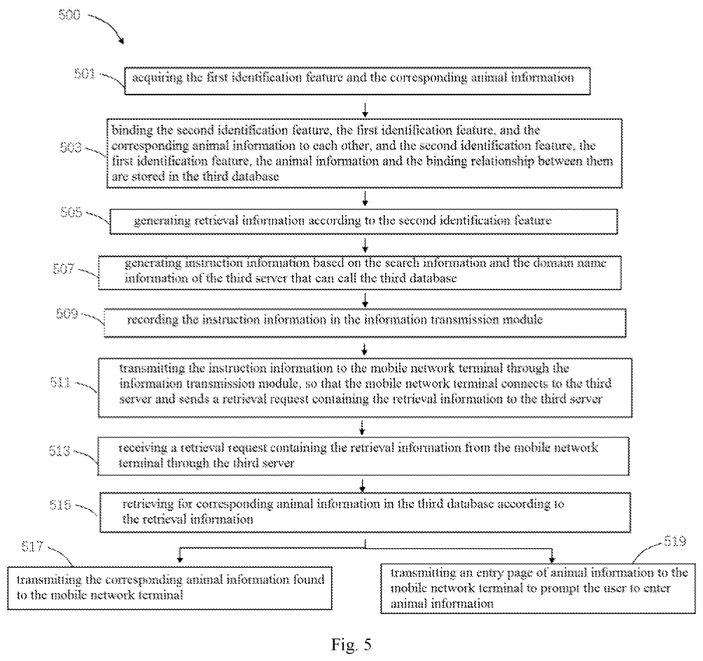

FIG. 5 is a flow chart of a method 500 for querying animal tag information according to the third embodiment of the present disclosure. Referring to FIG. 5, the method includes steps 501-519, wherein steps 501-509 relate to a method for modifying animal tags, and steps 509-519 relate to subsequent mobile interaction steps.

In step 501, acquiring the first identification feature and the corresponding animal information. In some embodiments, step 501 includes deriving the first identification feature and the corresponding animal information from the first database. In some other embodiments, step 501 includes: obtaining the chip identification code (i.e, the first identification feature) of the first electronic tag from the web site of the international organization that manages the chip, such as the official organization website of the ISO ICAR; and searching for the corresponding animal information on the relevant animal information website according to the obtained chip identification code of the first electronic tag.

In step 503, binding the second identification feature, the first identification feature, and the corresponding animal information to each other, and the second identification feature, the first identification feature, the animal information and the binding relationship between them are stored in the third database. Wherein, the second identification feature may be the unique identification feature of the second electronic tag, such as: the second chip identification code or the unique code number obtained after processing or encrypting the second chip identification code. And the second identification feature can also be other unique features that can distinguish each other.

In step 505, generating retrieval information according to the second identification feature.

In step 507, generating instruction information based on the retrieval information and the domain name information of the third server that can call the third database.

In step 509, recording the instruction information in the information transmission module, wherein the information transmission module is provided outside the animal and configured to transmit the instruction information to the mobile network terminal.

In step 511, transmitting the instruction information to the mobile network terminal through the information transmission module, so that the mobile network terminal connects to the third server and sends a retrieval request containing the retrieval information to the third server.

In step 513, receiving a retrieval request containing the retrieval information from the mobile network terminal through the third server.

In step 515, retrieving for corresponding animal information in the third database according to the retrieval information.

In the case that there is matching animal information, step 517 is executed, that is, transmitting the corresponding animal information found to the mobile network terminal. Specifically, the original display page of the animal information generated by the first server can be sent directly; or the display page generated by the third server containing the corresponding animal information can be sent.

In the case that there is no matching animal information, step 519 is executed, that is, transmitting an entry page of animal information to the mobile network terminal to prompt the user to enter animal information. Specifically, the entry page of the animal information may be generated by the first server, or may also be generated by the third server.

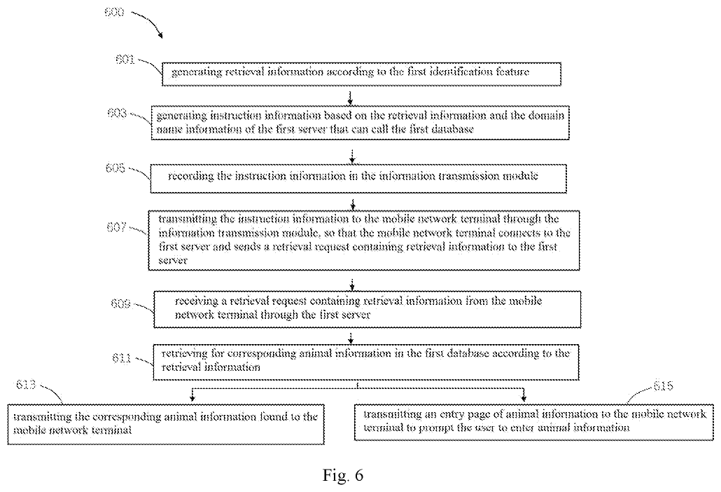

FIG. 6 is a flow chart of a method 600 for querying animal tag information according to a fourth embodiment of the present disclosure. Referring to FIG. 6, the method 600 includes steps 601-615, wherein the steps 601-605 relate to the method of modifying animal tags, and the steps 609-615 relate to the subsequent mobile interaction steps.

In step 601, generating retrieval information according to the first identification feature. The first identification feature can be directly derived from the first database, or obtained through a query on the website of an international organization that manages the chip, or directly read from the first electronic tag through a card reader. In some embodiments, step 601 includes generating retrieval information according to the chip identification code of the first electronic tag.

In step 603, generating instruction information based on the retrieval information and the domain name information of the first server that can call the first database.

In step 605, recording the instruction information in the information transmission module.

In step 607, transmitting the instruction information to the mobile network terminal through the information transmission module, so that the mobile network terminal connects to the first server and sends a retrieval request containing retrieval information to the first server.

In step 609, receiving the retrieval request containing retrieval information from the mobile network terminal through the first server.

In step 611, retrieving for corresponding animal information in the first database according to the retrieval information.

If there is matching animal information, step 613 is executed, that is, transmitting the corresponding animal information found to the mobile network terminal.

In the case that there is no matching animal information, step 615 is executed, that is, transmitting an entry page of animal information to the mobile network terminal to prompt the user to enter animal information.

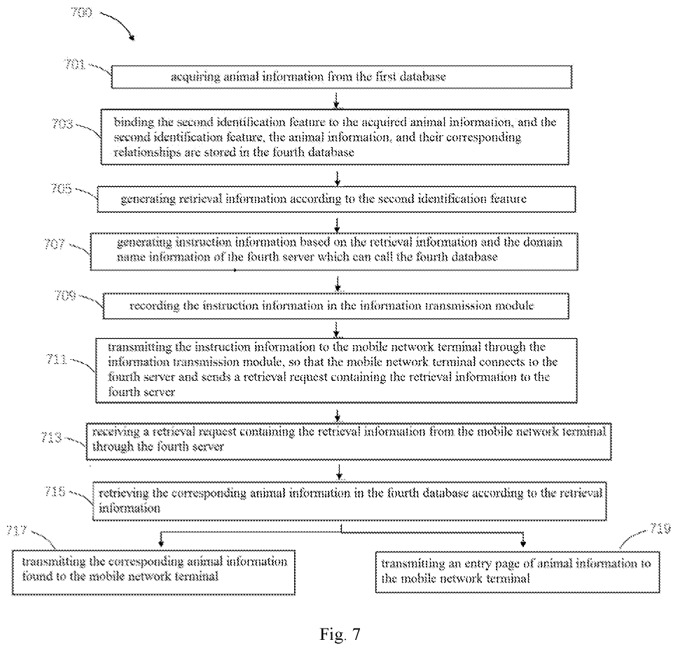

FIG. 7 is a flow chart of a method 700 for querying animal tag information according to the fifth embodiment of the present disclosure. Referring to FIG. 7, the method 700 includes steps 701-719, wherein the steps 701-709 relate to the method for modifying the animal tag, and the steps 711-719 relate to the subsequent server response step.

In step 701, acquiring animal information from the first database, that is, the animal information here refers to existing animal information that has been bound to the first identification feature.

In step 703, binding the second identification feature to the acquired animal information, and the second identification feature, the animal information, and their corresponding relationships are stored in the fourth database.

In step 705, generating retrieval information according to the second identification feature.

In step 707, generating instruction information based on the retrieval information and the domain name information of the fourth server which can call the fourth database.

In step 709, recording the instruction information in the information transmission module.

In step 711, transmitting the instruction information to the mobile network terminal through the information transmission module, so that the mobile network terminal connects to the fourth server and sends a retrieval request containing the retrieval information to the fourth server.

In step 713, receiving a retrieval request containing the retrieval information from the mobile network terminal through the fourth server.

In step 715, retrieving the corresponding animal information in the fourth database according to the retrieval information.

In the case that there is matching animal information, step 717 is executed, that is, transmitting the corresponding animal information found to the mobile network terminal.

In the case that there is no matching animal information, step 719 is executed, that is, transmitting an entry page of animal information to the mobile network terminal to prompt the user to enter animal information.

By constructing the mobile interaction function of the existing animal tag, the above embodiment makes the animal information associated with the existing animal tag can be easily obtained by the mobile network terminal, which greatly shortens the time to obtain the relevant animal information and improves the efficiency of animal management. In the case of animal loss, the person who finds the animal can conveniently query the information of owner of the animal through the mobile network terminal, and then contact the owner, so as to improve the probability of the animal being retrieved.

Those of ordinary skilled person in the art can understand that the above-mentioned embodiments are specific embodiments for realizing the present disclosure, and in practical applications, various modifications can be made in form and details without departing from the spirit and scope of the present disclosure.

What is claimed is:

1. A mobile interaction device of an animal tag, wherein the animal tag comprises a first electronic tag for implanting in an animal, the first electronic tag is provided with a first identification feature, the first identification feature is configured for binding to animal information of the animal, and the mobile interaction device comprises:
an information transmission module which carries instruction information, and the information transmission module is provided outside the animal and configured for transmitting the instruction information to the mobile network terminal, so as to make the mobile network terminal connect with a server to query the animal information;
the instruction information comprises retrieval information and domain name information of the server; the retrieval information uniquely corresponds to the first identification feature or the animal information bound to the first identification feature.

2. The mobile interaction device according to claim 1, wherein the information transmission module comprises a second electronic tag, the second electronic tag is configured to transmit the instruction information to the mobile network terminal through a radio frequency signal.

3. The mobile interaction device according to claim 2, wherein the second electronic tag is provided with a second identification feature, the second identification feature is bound to at least one of the first identification feature and the animal information, and the retrieval information is generated according to the second identification feature.

4. The mobile interaction device according to claim 2, wherein the second electronic tag comprises a NFC tag, and the mobile network terminal comprises a NFC communication module.

5. The mobile interaction device according to claim 1, wherein the information transmission module comprises an image display element, and the instruction information is transmitted to the mobile network terminal through an image signal by the image display element.

6. An animal tag system, comprising:
a first electronic tag for implanting in an animal, the first electronic tag is provided with a first identification feature, and the first identification feature is configured for binding to animal information of the animal; and
an information transmission module which carries instruction information, the information transmission module is provided outside the animal and configured for transmitting the instruction information to the mobile network terminal, so as to make the mobile network terminal connect with a server to query the animal information;
wherein the instruction information comprises retrieval information and domain name information of the server; the retrieval information uniquely corresponds to the first identification feature, or uniquely corresponds to the animal information bound to the first identification feature.

7. A method for modifying an animal tag, wherein the animal tag comprises a first electronic tag for implanting in an animal, the first electronic tag is provided with a first identification feature, and the first identification feature is configured for binding to the animal information of the animal, the mobile interaction method comprises:
generating retrieval information uniquely corresponding to the first identification feature or the animal information, wherein the animal information is animal information bound to the first identification feature;
generating instruction information for connecting to a server to query the animal information, wherein the instruction information comprises the retrieval information and domain name information of the server; and
recording the instruction information in an information transmission module, wherein the information transmission module is provided outside the animal and configured to transmit the instruction information to a mobile network terminal.

8. The method according to claim 7, wherein the step of generating the retrieval information comprises: generating the retrieval information according to the first identification feature.

9. The method according to claim 7, wherein the step of generating the retrieval information comprises: binding second identification feature with at least one of the first identification feature and the animal information; and generating the retrieval information according to the second identification feature.

10. The method according to claim 7, wherein the step of recording the instruction information in the information transmission module comprises: writing the instruction information into the second electronic tag, wherein the second electronic tag is configured to transmit the instruction information to the mobile network terminal through the radio frequency signal.

11. The method according to claim 7, wherein the step of recording the instruction information in the information transmission module comprises: compiling the instruction information into an image; and displaying the image on an image display element, wherein the image display element is configured to transmit the instruction information to the mobile network terminal through the image signal.

12. A method for querying information of an animal tag, wherein the animal tag comprises a first electronic tag for implanting in an animal, the first electronic tag is provided with a first identification feature, and the first identification feature is configured for binding to the animal information of the animal; the method comprises:
generating retrieval information uniquely corresponding to the first identification feature or the animal information, wherein the animal information is the animal information bound to the first identification feature;
generating instruction information for connecting to a server to query the animal information, wherein the instruction information comprises the retrieval information and the domain name information of the server;
recording the instruction information in an information transmission module, and the information transmission module is provided outside the animal;
transmitting, by the information transmission module, the instruction information to the mobile network terminal to enable the mobile network terminal to connect with the server and send the retrieval information;
retrieving, by the server, the corresponding animal information according to the retrieval information after receiving the retrieval information; and
transmitting the corresponding animal information to the mobile network terminal in the case that there is matching animal information.

13. The method according to claim 12, further comprising: transmitting an entry page of the animal information to the mobile network terminal in the case that there is no matching animal information.
